(19) United States
(12) Patent Application Publication
(10) Pub. No.: US 2011/0286313 A1
(43) Pub. Date: Nov. 24, 2011

(54) LED ANALOG CLOCK OR WATCH DISPLAY

(75) Inventor: Phillip Stanley Reingold, Mukilteo, WA (US)

(73) Assignee: Phillip Reingold, Mukilteo, WA (US)

(21) Appl. No.: 12/783,556

(22) Filed: May 20, 2010

(51) Int. Cl. G04C 17/00

(52) U.S. Cl. 368/241

(57) ABSTRACT

The Clock Face or Watch Face contains two physically separate and non-concentric circles of Light representing Hours and Minutes and an Arc representing Seconds. The Hours fill in 12 smaller circles with Light as the Hours pass and the Minutes fill in 12 smaller circles with Light as 60 minutes pass.

The differentiation of LED Colors within a circle of Light allows the viewer to easily determine the Light filled Section of each Larger Ellipse or Circle for the current Hour or Minute. The use of a distinct LED or Light color for the 90 Deg increments within an Ellipse or Circle eliminates or reduces the need to count circles of Light to quickly identify the current time. The 12 o'clock, 3 o'clock, 6 o'clock and 9 o'clock positions are on 90 Deg Increments and have a separate distinct Light color from the other Lighted positions within the Hour's Ellipse or Circle.

### REFERENCE CITED: US PATENT DOCUMENTS

| U.S. Ser. No. 61/216,617 | May 2009 | Phillip Reingold |
|---|---|---|
| D453,114 | July 2001 | Phillip Reingold |
| 4,920,524 | April 1990 | Kotob |
| 4,254,487 | March 1981 | Lee |
| 3,958,409 | May 1976 | Manber |
| 3,841,082 | October 1974 | Cuevas |

### FIELD OF THE INVENTION

This invention relates to an LED Analog Clock or Watch Display. The Display uses a distinct and novel approach without the use of Clock Hands or Digits to allow the viewer to quickly determine the current time. The use of Lights along with separate Ellipses or Circles gives the viewer an intuitive illumination of Time using 3 or 4 different LED Colors. Each LED Color clarifies simply to the viewer what the current time is. The Seconds Arc or Line is made up of 5 to 30 smaller circles representing the passage or seconds or time passing by. Further, the invention uses within each of the two Larger Ellipse or Circles 3 to 4 distinct Light or LED Colors combined with the filling in of each of the larger Ellipses or Circles of Light or LEDS to give the viewer the current time. This invention eliminates the confusion of having only one Light “on” representing the current hour and one Light “on” representing the current 5-minute interval and adds the Arc of Light representing seconds as a new addition.

### BACKGROUND OF THE INVENTION

Previous art defines an Analog Clock or Watch Display with a single ellipse or circle with 2 Clock Hands in a mechanical movement or separate ellipses or circles with mechanically coupled hands. Advancements in prior art have been made at using Light to display time in an analog manner similar to clock hands or combined Light with clock hand or the traditional digital manner with lighted LED digits representing the current hour and minute.

German Patent Publication No. 2,725,029 discloses a timepiece with an analog display using LEDS or LCD arranged in a point Of line raster. The display comprises concentric rings each with 60 elements for minutes and seconds. The number of elements and the need to discern the correct time is difficult due to the density of elements within the clock or watch face.

The use of 12 circles in U.S. Pat. No. 4,007,583 with one circle illumination to the current hour and one other circle illuminated in blinking manner indicating the current 5 minutes or 1 minute if there are 60 light elements for minutes. In prior art, the Light elements for the hours and minutes are concentric within the clock or watch face as illustrated in U.S. Pat. No. 4,920,524 where the elements are illuminated in sequence to display the current time.

Further, the use of separate colors goes a step further to illustrate the current hour, minute and second is illustrated. Having the current hour as the smallest concentric circle however obscures the significance of the current hour. The density of the sixty red LED's representing the current minute illuminated in sequence to mimic a clock hand makes the discerning of the current time difficult to determine. The inventor even acknowledges this by having a teaching mode wherein every 5^{th} minute is illuminated in sequence noting the significance of the observer being interested in the time to the nearest 5^{th} minute. The 5^{th} minute is having significance to the analog clock markings for both the hour and 5 minutes of passage.

This prior art falls short due to the arrangement of LEDS with Hours being the smallest of the concentric rings inverse to its time significance and arranging all time elements within the same series of rings of light elements as well as sequentially illuminated the elements with one element “on” at a time that requires the viewer to spend some effort to determine the current time.

Other art recently patented utilizes a combination of Light and a clock hand to give the viewer the current time. Other art in the marketplace utilizes separate locations in an unfamiliar format of rectangular lights in different colors for minutes and hours with binary arithmetic necessary to give the current time that falls short of an intuitive glance to perceive the current time.

The prior art utilizing Light falls short of allowing the viewer to quickly determine the current time. This is evident especially in the dark or at large distance from the clock where the other non-illuminated portion of the clock face is unlit or in the case of the binary lights, the viewer does not intuitively know what the lights represent. Deviation from the familiar analog clock face maybe unique in prior art, but does not provide the necessary intuitive recognition of time at a glance.

The spatial improvements as well as the number or circles and their positions within each ellipse within this invention are supported by previous art Design Pat. No. D453,114 that illustrates the Hour's Ellipse and the Minute's Ellipse as well as the Second's Arc all within the ornamental design.

In order to overcome the deficiencies of prior art, a means of quickly identifying time in an intuitive manner is required. This will allow the viewer to deduce the current time both in daylight and at night without the use of any text, numerals or printed graphics.

### SUMMARY OF THE INVENTION

The present invention overcomes problems associated with prior art. The invention has 5 distinct parts that combine to provide the viewer a quick and understandable means in a pseudo analog manner utilizing lights to display the correct time.

These are (1) physical spatial separation of the Hour's and Minute's Ellipses or Circles so that Hours and Minutes lights are physically separated, (2) that the Hour's Ellipse or Circle of Lights is visibly larger in size to the Minute's Ellipse or Circle of Lights, (3) the use of 3 or 4 Light colors with one Light color representing 90 Degree time position increments within the Hour's Ellipse or Circle and the Minute's Ellipse or Circle, the 2^{ND} Light or LED Color representing the other time position increments of the Hour's time within the Hour's Ellipse or Circle, and the 3^{RD} Light or LED Color representing the other 5 minute time increments within the Minute's Ellipse or Circle and (4) the filling in of each position of each ellipse or circle with Light at the designated Hour or Minute and keep the previous Lights illuminated so that all previous time increments to the current time remain illuminated until all positions of time are illuminated except the 12 o'clock position and the 60 min position. The next position of time, all lights reset to ‘off’ except the 12 o'clock position Light or LED and the 0 min Light or LED are illuminated to the ‘on’ indication. At that time of 12:00, the process starts over with one illuminated position within the Hour's Ellipse or Circle and one illuminated position within the Minute's Ellipse or Circle. (5) The separate and distinct Arc or new and yet familiar way of illustrating time. The invention combines the use of two separate ellipses or circles each being made up of 12 smaller circles for the current hour and 12 smaller circles for the current 5 minutes and a separate distinct arc or line of Lights or Line of Lights comprised of either 5 or 10 smaller circles represents the seconds. These also fill in until either the 5^{th} or 10^{th} second is reached at which all seconds circles turn off and the process repeats itself. The 4^{TH} Light or LED distinct Color.

By combining these five improvements, one can view the clock or watch face whether night or day and quickly deduce the current time. In resolving the time, the viewer would look at the portion of the Ellipse or Circle illuminated, the largest 90 Degree increment Light that is illuminated and at most count 2 increments past that position to identify the current Hour and with the separate Ellipse or Circle for Minutes in a similar manner to the current Hour the current 5 minute increment can be readily identified quickly.

### BRIEF DESCRIPTION OF THE DRAWINGS

FIG. 1 illustrates the spatial separation of the Hour's Ellipse or Circle from the Minute's Ellipse or Circle, the position of the 12 circles within the Hour's Ellipse or Circle and the position of the 12 circles within the Minute's Ellipse or Circle for a total of 24 circles.

FIG. 2 illustrates the time of 4:35 AM or 4:35 PM. The Hour's Ellipse or Circle has 5 positions or circles illuminated with 2 separate Light colors within the ellipse representing the 4: AM or PM as the current Hour. The Minute's Ellipse or Circle has 8 positions or circles illuminated with 2 separate Light colors within the ellipse representing the current Minutes as: 35 AM or PM as the current minutes. The Hours and Minutes ellipses are shown all within one clock face.

FIG. 3 illustrates the time of 4:35 AM or 4:35 PM all within 2 separate clock faces.

FIG. 4 illustrates the implementation of the Hour's ellipse utilizing a circuit board that has 4 LEDS within each Hour's Position.

FIG. 5 illustrates the implementation of the Second's Arc

### DESCRIPTION OF THE SPECIFIC EMBODIMENTS

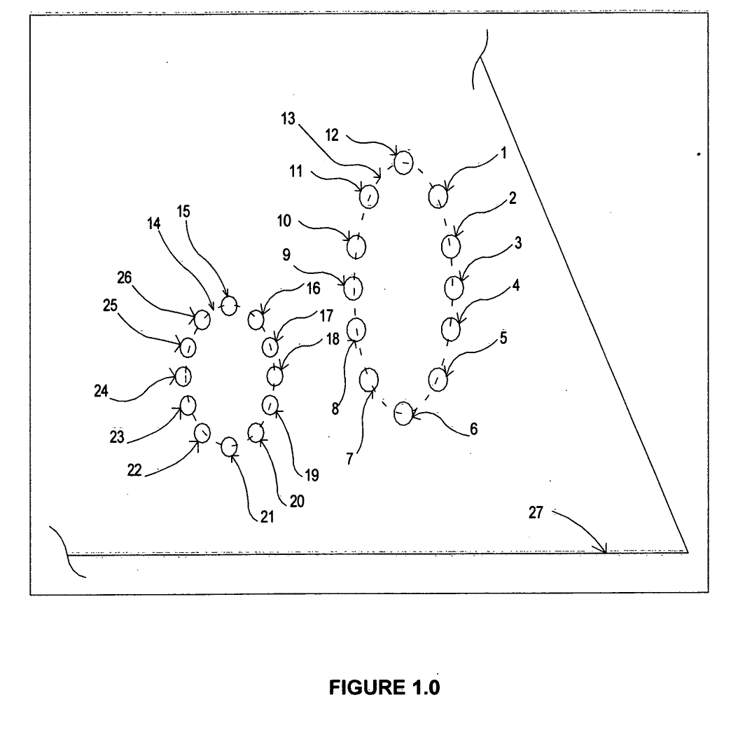

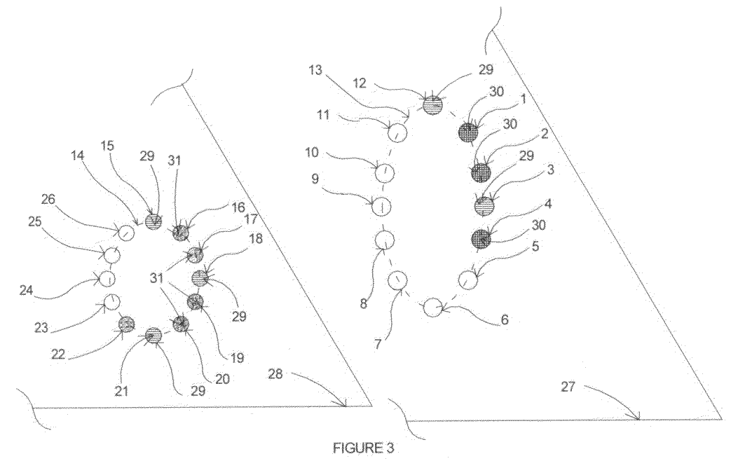

The present invention is defined per FIG. 1 as two separate Ellipses or Circles 13 & 14 that represent Hours and Minutes of time respectively that are within the same Clock Face 27 or on separate Clock Faces 27 & 28 per FIG. 3. The shape of each Clock Face can be triangular or rectangular or circular or an irregular shape. The separation of the Hour's Ellipse or Circle and the Minute's Ellipse or Circle is critical to the use of light to represent the current time.

The Hours are present in ellipse or circle 13 and Minutes are present in ellipse or circle 14. The hour positions are identified within FIG. 1 as circle 1 to circle 12 representing 1 o'clock to 12 o'clock respectively. The Minute positions are identified within FIG. 1 as circle 15 to circle 26 representing 0 minutes to 55 minutes respectively in 5-minute increments.

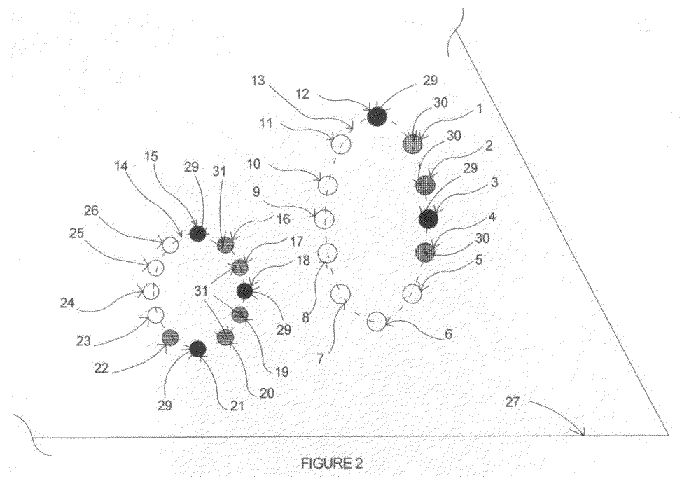

Referring to FIG. 2, the operation of the present invention is illustrated by illumination of the 12 o'clock, 1 o'clock, 2 o'clock, 3 o'clock and 4 o'clock circles within Hour's ellipse 13. In deducing the current Hour as 4, the viewer would see the highest position 4 o'clock circle 4 within the Hour's ellipse or circle 13, the portion of the ellipse or circle 13 that is illuminated and that the 12 o'clock circle 12 and 3 o'clock circle 3 positions are illuminated with LED Color 29 and that the positions at 1 o'clock circle 1, the 2 o'clock circle 2, and the 4 o'clock circle 4 are illuminated with LED Color 30.

In deducing that the current minutes as 35 minutes within Minute's ellipse or circle 14, the viewer would see the highest 5-minute increment, which in this case is circle 22 that represents the 35-minute position, the portion of Minute's ellipse or circle 14 that is illuminated and that the 0 minutes, 15 minutes, 30 minutes position are illuminated with LED Color 29 and that the 5 minutes, 10 minutes, 20 minutes, 25 minutes, 35 minutes positions are illuminated with LED Color 31. This use of the four improvements of the present invention to prior art allows the viewer to deduce current time as 4:35 AM or 4:35 PM.

Expanding the detail of what is illustrated, these improvements relate to viewer tendencies in determining the current time. The tendency is to look at the number of hours that have elapsed from the 12 o'clock position and the number of minutes that have elapsed from the 0 minutes position is addressed with the filling in of previous positions with light. The use of 90 Deg increments within each of the ellipses with a different LED Color relates to the tendency of the viewer to identify quickly the quarter hour, the half hour, the three quarters hour and the hour. This tendency extends as well to 15 minutes after the hour, 30 minutes after the hour and 45 minutes after the hour. The tendency to view size as it relates to importance is addressed by making the Hour's ellipse or circle 13 visibly larger than the Minute's ellipse or circle 14. The use of separate ellipses physically separates in the viewers mind each the pieces of information. Finally, the methods used in the present invention allow the viewer to easily relate prior art in the form of clock hands to the use of light.

FIGS. 1 & 2 & 3 illustrate further the use of Lights or LEDS to display the current time. The Hour's ellipse or circle 13 and Minute's ellipse or circle 14 each contains 12 smaller regularly spaced circles at visually spaced symmetric increments to represent Hours and Minutes respectively. The Hour's Ellipse or Circle 13 has smaller spaced circles 1 to 12 positioned so as to represent positions of the Hours of the clock. The topmost of the smaller circles of Hour's Ellipse or Circle 13 is positioned at the 12 o'clock position and the bottom most circle 6 within the Hour's Ellipse or Circle 13 is positioned at the 6 o'clock position. The other circles are spaced regularly and symmetric at predefined positions of Hour's Ellipse or Circle 13 between the topmost circle 12 and the bottom most circle 6. The Clock Face 27 and the positions of each of the smaller circles from 1 to 12 are illustrated in FIG. 1.

The Minute's Ellipse or Circle 14 has smaller circles within it and is represented by a total of 12 regularly spaced and symmetric circles positioned so as to represent positions of the Minutes of the clock in 5 minute intervals for a total of 60 minutes. Each smaller circle of Minute's Ellipse or Circle 14 represents 5 minutes of time. The Clock Face 27 or Clock Face 28 using separate clock faces for the Hours & Minutes has a Minute' Ellipse or Circle 14 that has within its circumference 12 smaller spaced circles identified as circles 15 to 26. The circle 15 is the topmost circle and represents 0 minutes. The bottom most circle 21 within the Minute's Ellipse or Circle 14 represents 30 minutes of time.

Each circle representing a specific hour of Hour's Ellipse or Circle 13 is illuminated using 1 to 4 LEDS. The number of LEDS representing a specific hour such as within circle 1 would increase beyond 4 with a larger clock face. As time increases from the 12 o′clock position as a Starting point in time, each smaller circle starting from circle 12 illuminates sequentially with the previous circle remaining illuminated. Each previously illuminated circle remains illuminated until the 12 o'clock position is again reached and 12 hours of time have elapsed. At the 11 o'clock position, the 12 o'clock position is turned off to avoid confusion by having all positions illuminated. When the 12 o'clock position is reached then all previously illuminated circles all turn off and the cycle starts over with the 12 o'clock position illuminated. In other words, the LEDS of each circle fill in with illuminated light around the Hour's Ellipse or Circle 13 to indicate the current hour of time. If the current time is 3 o'clock then circles 12, 1, 2 & 3 are illuminated. Circles 4, 5, 6, 7, 8, 9, 10 and 11 are not illuminated. The filling in of lights and the use of two different colors for the lights or LEDS allows the viewer to easily determine the current time.

The invention provides for immediate viewing of the correct time with a quick glance be marking the LED Color 29 of the 12 o'clock circle 12 and the 3 o'clock circle 3 as these are at the 0 Degrees position and the 90 Degrees position of the Hour's Ellipse or Circle 13 while LED Color 30 is illuminating circles 1 & 2. In this way, counting of illuminated holes or circles is minimized and in this case avoided.

At the 4 o'clock hour, circles 12, 1, 2, 3 and 4 are of Hour's Ellipse or Circle 13 are illuminated. FIG. 2.0 illustrates a view of the illuminated circles of Hour's Ellipse or Circle 13 and the Minute's Ellipse or Circle 14. Circle 4 is illuminated and Hour's Circles 12, 1, 2, 3 are also illuminated and Circle's 12 & 3 Lights or LEDS are a different Light or LED Color 29 from Circle 4 LED Color 30. The viewer see one quarter of the Hour's Ellipse or Circle 13 illuminated would count one circle past circle 3 the 3 o′clock position as being illuminated to determine the 4 o′clock position.

The use of 2 sets of LED Colors 29 & 30 in the Hour's Ellipse or Circle 13 and 2 sets of LED Colors 29 & 31 for the Minute's Ellipse or Circle 14 allows for quick identification time Assuming LED Color 29 is yellow for example and LED color 30 is green for example the following paragraphs apply. In Hour's Ellipse or Circle 13, Circles 12, 3, 6, 9 are illuminated with Light or LED Color 29 and Circle's 1, 2, 4, 5, 7, 8, 10, 11 are illuminated with Light or LED Color 30. The Minute's Ellipse or Circle 14 is illuminated with 2 Light or LED Colors that indicate the current Minutes time to a 5 minute interval. That is, when the next 5 minutes of time are reached, then the next 5-minute circle illuminates while keeping the previous illuminated circles. These circles are Light or LED Color 31 as blue for example and Light or LED Color 29 as yellow for example. The Minute's Circles 15, 18, 21, 24 which represent 0 minutes, 15 minutes, 30 minutes and 45 minutes respectively are illuminated with Light or LED color 29 as blue for example and the Circles 16, 17, 19, 20, 22 and 23 are illuminated with LED color 31 as yellow for example.

If the current time in minutes is 35 minutes after the hour, then the following circles of the Minute's Circle or Ellipse 14 are 15, 16, 17, 18, 19, 20, 21 and 22 and would all illuminated. These represent the following time increments as 0 min, 5 min, 10 min, 15 min, 20 min, 25 min, 30 min, and 35 min respectively. Since circle 21 represents the 30 min time and is illuminated with Light or LED color 29 as blue for example and circle 22 represents the 35 min time and is illuminated with Light or LED color 31, the minutes can be observed as 35 minutes by viewing the half circle of lights plus 1 hole past the half hour. The invention allows for the immediate identification of time without the need to count total number of holes or circles illuminated to indicate the current Minutes time.

The illumination of each of the Hour's Ellipse or Circle 13 and the Minute's Ellipse or Circle 14 as separate from each other is essential to identify the current time immediately by spatially separating the illumination of the 2 Circles. Previous art shows the LED Hours, Minutes and Seconds Circles to be concentric with each other as per a clock that shows Clock Hands with 1 Ellipse or Circle. With the elimination of Clock Hands and the use of Lights or LEDS, it is difficult to quickly identify the current time due to the viewer visually blending of the Hour's Circle Lights with the Minute's Circle Lights.

The invention of a novel and improved design uses 3 or 4 different Light or LED Colors at that are located at the appropriate positions of a standard clock ellipse and separated into two ellipses or circles, the use of Lights filling in Hours and Minutes Ellipses or Circles that are spatially separated and are not concentric all within one Clock Face or alternatively in separate Clock Faces to display the current time.

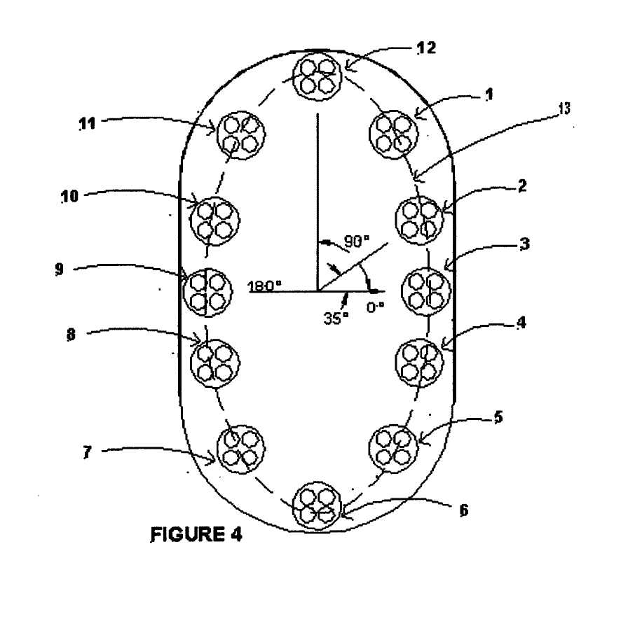

Referring to FIG. 4, illustrated is an implementation of the Hour's Ellipse or Circle 13 within a printed circuit board layout. The Hour's circles 1 to 12 are each implemented at the typical locations of a standard clock with each of the circles of the Hour's Ellipse or Circle containing a group of 4 LEDS. The location of each of these circles is placed symmetrically and at specific angular intervals with respect to the center of the printed circuit board that is the 0 Deg point to the right of center. Angular displacements are illustrated for the 3 o'clock position to the 2 o'clock position that is 35 Deg from the initial side angle point. The 90 Deg positions are at the 12 o'clock position at 90 Degrees, to the 3 o'clock position at 0 Degrees, the 6 o'clock position at 270 Degrees position and the 9 o'clock position at 180 Degrees. Referring to FIGS. 2 and 3, it is the 90 Deg increments of rotation that are a different Light or LED Color versus the other positions that are non 90 Deg increments of rotation for the Hour's Ellipse or Circle that are differentiated by a separate Light or LED Color.

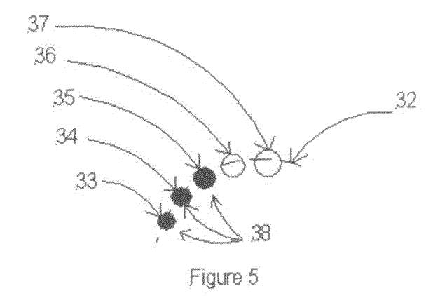

The Second's Arc is illustrated per FIG. 5.0. The current seconds are 3 seconds of a 5-second increment. This could be 3 seconds from the start of a minute or it could be 8 seconds from the start of a minute or it could be 13, 18, 23, 28, 33, 38, 43, 48, 53, 58 seconds from the start of a new minute. The main intent of this part of the invention is to give the viewer the sense of time movement as they are observing the current time and immediately allow one to understand the intent of the light movement with time. This is illustrated by the illumination of lights filling in this arc of light starting from circle 33 to circle 38 of Second's Arc 32. FIG. 5.0 has Second's Arc 32 filled in with illuminated circles 33, 34 and 35 using LED Color 38 while circles 36 and 37 are “off” and not illuminated. Once all circles Of the Second's Arc fill in and are all illuminated at 5 seconds and then at 5-½ seconds all Second's circles turn “off” and the process repeats counting off increments of 5 seconds from the start of each minute. Within the Second's Arc, 5 seconds are given individual smaller circles with the possibility that this arc could be another shape as a line and the number of seconds could be 10 seconds or 30 seconds. The number of Seconds while accurate are used to convey the movement of time to the observer.

1. A Clock or Watch, with Clock or Watch Display Face or Faces comprising:
a. Two Ellipses or Circles and an Arc with the physical separation of an Hour's Ellipse or Circle from A Minute's Ellipse or Circle in one or more Clock Faces or Watch Face as these are combined to display the current time in Hours and Minutes utilizing illuminated Circles of Light.
b. The physical size of the Hour's Ellipse or Circle is visibly larger than the Minute's Ellipse or Circle in relation to the significance of Hours as to Minutes.
c. Within the Hour's Ellipse or Circle there are 12 smaller circles of Light representing the Hours of time.
d. Within the Minute's Ellipse or Circle there are 12 smaller circles of Light representing 60 Minutes of time equivalent to the passage of one Hour. Each of the smaller circles within the Minute's Ellipse or Circle represents 5 Minutes of time.
e. A Separate Arc, Curve or Line of Light Made up of 5 to 30 circles representing Seconds.

2. The Hour's and Minute's Ellipses or Circles in claim 1 are illuminated in a sequential manner with the previous Hour or 5 Minutes remaining illuminated to show the current time as a circular section of Light in each of the separate Ellipses or Circles.

3. The illuminated Ellipses or Circles of Light as stated in claim 2 and defined in claim 1 are represented by 3 separate LED or Light Colors with one color dedicated to the 90 Deg Increments of the Circles and the other 2 colors representing the Hours and Minutes on non 90 Deg Increments of each Ellipse or Circle.

4. The introduction of a physically separate Seconds Arc or Line or Curve of Light in the Clock Face, Watch Face Or Clock Faces identified in claim 1 to show the passage of time by filling in the Seconds as time passes as per claim 2 where the previous second remains illuminated until the entire Arc or Line or Curve is filled in with light.
